(19) United States
(12) Patent Application Publication
(10) Pub. No.: US 2004/0180156 A1
(43) Pub. Date: Sep. 16, 2004

(54) Membrane body and method for the production thereof

(76) Inventors: Wolfgang Albrecht, Teltow (DE); Dieter Paul, Kleinmachnow (DE); Ronald Hilke, Teltow (DE); Thomas Weigel, Wilhelmhorst (DE); Thomas Groth, Berlin (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 10/775,823

(22) Filed: Feb. 10, 2004

Related U.S. Application Data
(63) Continuation-in-part of application No. PCT/DE02/02796, filed on Jul. 31, 2002.

(30) Foreign Application Priority Data
Aug. 10, 2001 (DE) 101 38 319.3

(51) Int. Cl. F16L 1/00

(52) U.S. Cl. 428/34.1

(57) ABSTRACT

In a membrane body and a method for producing such a body, at least one hollow membrane is provided which is joined to, and at least partially surrounded by, a flat membrane to form a combined hollow and flat membrane body for separating more than one component from a fluid mixture.

This is a Continuation-In-Part Application of International Application PCT/DE02/02796 filed Oct. 31, 2002 and claiming the priority of German application 101 38 319.3 filed Aug. 10, 2001.

### BACKGROUND OF THE INVENTION

The invention resides in a membrane body and in a method for producing such a membrane body.

Micro-, ultra-, and nanofiltration membranes are generally manufactured from solutions of polymers. In conventional methods for the manufacture of flat membranes, the polymer solution is applied as a film to a support structure using a casting box, a wiper or a slot-nozzle and the solvent is then evaporated possibly while the support structure is moved through an evaporation chamber. Then the polymer on the substrate is subjected to a coagulation medium. In the coagulation medium, the polymer film solidifies and forms a membrane. Such manufacturing methods. are described for example in the book “Membran und Membrantrennprosesse, Grundlagen und Anwendungen” (VCH Verlags-gesellschaft mbH, Weinheim 1992).

In this state of the art, furthermore hollow fiber membrane modules for example for the drying of gases (compressed air) are known. DE 197 46 752 A1 describes such a module of a membrane body and a housing which includes connections for the introduction and the discharge of a (humid) air flow, the dried air flow and the permeate flow which contains the water vapors removed from the air. The membrane body itself consists of a bundle of hollow fiber membranes whose individual hollow fibers are open at their ends. The feed flow is conducted through the lumen of the hollow fibers, the water vapor permeates through the membrane and the dried air leaves the hollow fibers at their opposite ends.

Furthermore, membrane modules are known wherein a small hollow fiber membrane is disposed within a larger hollow fiber membrane. But the construction of such a module is quite complicated. In addition, the manufacturing process is discontinuous.

Based on this state of the art, it is the object of the present invention to provide a membrane body of a simple design which is also easy to manufacture. In addition, the membrane body should be capable to separate more than two components from a medium.

### SUMMARY OF THE INVENTION

In a membrane body and a method for producing such a body, at least one hollow membrane is provided which is joined to, and at least partially surrounded by, a flat membrane to form a combined hollow and flat membrane body for separating more than one component from a fluid mixture. The hollow membrane and the flat membrane are always joined by way of a contact area. With the combined arrangement of hollow and flat membranes, the membrane body is capable of separating at the same time at least three components. With a larger number or, respectively, additional combinations of hollow and flat membranes even more components can be separated. In such arrangements, the membranes may consist of different materials.

With the arrangement and the embodiment of hollow membranes and flat membranes a membrane body of simple configuration can be provided which is furthermore easily controllable and easy to manufacture.

In an advantageous embodiment of the invention, the hollow membrane may be completely surrounded by only one flat membrane. In another embodiment, the hollow membrane is surrounded at least partially or in sections by at least two flat membranes which, dependent on the requirements of the membrane body, may consist of different materials.

In order to achieve a good separation of the media and to provide for a good stability of the membrane body, the hollow membrane and the flat membrane are joined. A good connection between the two membranes is formed particularly by lattice-like polymerization, for example, by way of a chemical or radio-chemical reaction.

It is further advantageous if the hollow membrane and/or the flat membrane consist of at least one polymer and/or a copolymer. Polymers or copolymers have proofed to be good and suitable materials in connection with membranes. The membranes or, respectively, the membrane materials may also be modified. A chemical modification can be achieved by a copolymerization or graft-copolymerization. The radio-chemical modification comprises photo- plasma- or electron beam methods, whereby a modification with respect to hydrophilic or hydrophobic properties and polar group or polar reactive groups can be achieved.

It is particularly advantageous if the hollow membrane comprises at least a second hollow membrane and/or is in the form of a hollow membrane mat, or respectively hollow membrane bundle, preferably of polypropylene. With the use of a membrane structure comprising an inner hollow fiber in a hollow fiber membrane, the utilization possibilities of a membrane body according to the invention are further expanded since a further separation stage by the second hollow fiber membrane can be established. In a configuration of the hollow membrane as a mat or a bundle, the hollow membrane can easily be arranged on a flat membrane. It has been found that polypropylene is a suitable material for manufacturing such a hollow membrane.

Further advantages are obtained if the flat membrane is manufactured from a polymer solution, particularly from a 10% polyacryl nitrile/dimethyl formamide polymer solution, since polymer solutions have been found reliable in the manufacture of flat membranes. This applies particularly to polyacrylnitrile/dimethyl formamide.

The mechanical stability of the membrane body can be increased by providing in the membrane body support means particularly in the form of particles fleeces or fibers. If the membrane body is exposed to relatively high mechanical stresses, the support means prevent a destruction of the membrane body. In addition, with the support means, the membrane may be shaped for adaptation to different applications.

It is also the object of the present invention to provide a method for manufacturing a membrane body wherein at least one hollow membrane is provided with a flat membrane such that the flat membrane at least partially surrounds the hollow membrane.

It is the aim of the method to combine hollow and flat membranes in such a way that a membrane body is formed which can separate at least three materials at the same time and to manufacture such a membrane body at relatively low costs.

In an advantageous embodiment of such a method the hollow membrane is fully surrounded by a flat membrane. Alternatively, the hollow membrane is enclosed by several, particularly between two, flat membranes.

Preferred embodiments of the manufacturing method for the membrane body according to the invention as described above will become more readily apparent from the following description of exemplary embodiments of the invention on the basis of the accompanying drawings.

### BRIEF DESCRIPTION OF THE DRAWINGS

FIG. 1 shows a first embodiment of the membrane body according to the invention,

FIG. 2a and FIG. 2b show modified embodiments of the membrane body, and

FIG. 3 shows another membrane body according to the invention.

### DESCRIPTION OF PREFERRED EMBODIMENTS

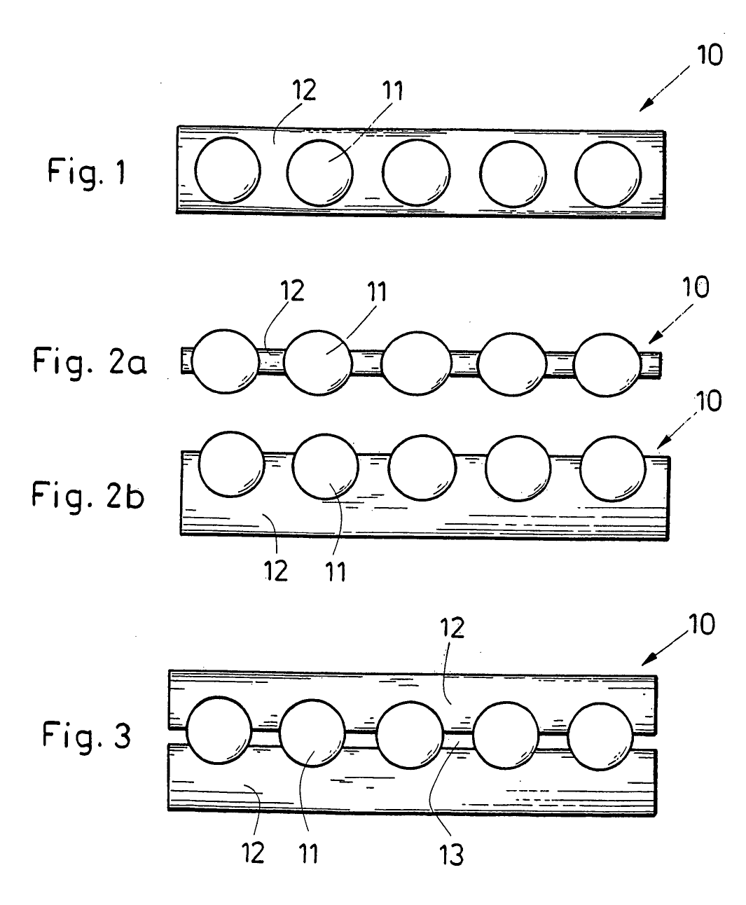

FIG. 1 shows a membrane body 10 in cross-section. The membrane body 10 comprises a flat membrane 12, into which hollow membranes 11 of circular cross-section are embedded. The hollow membranes 11 are completely surrounded by the flat membrane 12. In the manufacture of the membrane body 10, the hollow membranes 11 are manufactured separately before they are embedded in the flat membrane 12. Before the embedment, the hollow membranes may be present as individual membranes or as a bundle or in the form of a mat.

The hollow membranes 11 may be manufactured in a wet spin process (with or without evaporation stage) or in an extruder.

The hollow membranes 11 may be embedded in the flat membrane 12 by pulling a polymer solution with a wiper over the hollow membranes 11 or by means of a double-slot extrusion nozzle. With a double slot nozzle, one or several polymer layers may be applied to the opposite sides of a hollow membrane or a hollow membrane mat or bundle.

The flat membrane 12 as well as the hollow membrane 11 may consist of one or several polymers or, respectively, copolymers. The flat membrane 12 may furthermore comprise one or several layers of one or several polymers or, respectively copolymers.

In both membranes 11, 12, particles, fleeces, fibers or other membrane stabilization structures may be contained in order to form a mechanically stable membrane body.

As the hollow membrane 11, a common hollow membrane (also called hollow fiber membrane) may be used. It is of course also possible that another hollow fiber is disposed in the hollow fiber membrane.

In addition, the connection or interlacing of the two membranes 11, 12 can be improved by a chemical or radio-chemical reaction.

FIGS. 2a and 2b also show membrane bodies 10 in cross-section, wherein the hollow membrane 11 is only partially or, respectively, in sections surrounded by the flat membrane 12. While in the embodiment of FIG. 2a, the hollow membrane 11 and the flat membrane are arranged in an alternating pattern, in the embodiment of FIG. 2b, the hollow membranes are partially embedded in the flat membrane 12. A part of the hollow membrane 11 projects from the flat membrane 12.

In the arrangement shown in FIG. 3, the hollow membrane 11 is disposed between two flat membranes 12. The two flat membranes 12 at the top and the bottom sides of the hollow membranes 11 are not in contact with each other and form, in combination with two adjacent hollow membranes 11, an intermediate space 13. This intermediate space 13 may be used in certain application as an admission or discharge passage.

In all three exemplary embodiments, the membrane body 10 can be easily manufactured at low expenditures. The membrane body 10 can be manufactured in a continuous as well as in a discontinuous way.

In addition in accordance with the invention, several flat membrane layers with different properties with regard to permeability, selectivity etc. may be used.

Furthermore, several hollow membranes may be embedded concurrently or subsequently in several membrane layers of the same or different materials and one or several layers may then again be dissolved out of the compound structure. In this way, spaces, such as the intermediate space 13 of the embodiment shown in FIG. 3, may be formed.

Because of its capability of separating several materials, the material body according to the invention may be used in numerous areas.

Bioreactors including membranes are used for example in many biotechnological and biomedical areas where adhesion dependent and adhesion independent cells are cultured. The membranes act on one hand as diffusion barrier for controlling the entrance or exit of certain materials in a desired way. In a membrane body according to the invention, the hollow fiber can advantageously. be used for the oxygenation of a medium or cells. In addition, the membranes should serve as supports for adhesion dependent cells, wherein the cells are cultivated on one side of a flat membrane or in a hollow fiber membrane or, respectively, in the intermediate spaces (see FIG. 3) of a membrane body.

With a partial embedment of the hollow fiber membranes in the flat membrane, cells can be cultivated partially on the outside surface of the hollow fiber membranes and partially on the flat membrane surface. Such a hollow- and flat membrane construction permits therefore the admission of two or three supply media by way of one hollow or flat membrane for example an improved oxygen supply for the cells. A membrane body as shown in FIG. 3 for example can be used as a bioreactor for growing an artificial liver.

The membrane body according to the invention may also be used in the technical area, wherein the hollow membranes of the membrane body may act as additional material or heat barriers. Alternatively, the hollow membrane of the membrane body may have the function of a material or heat-exchange bridge. A medium flow through the hollow membrane depends on the respective application and is therefore application-specific and not always necessary.

One or both membrane types may be effective in a selective way in processes such as gas separation, pervaporation, vapor permeation or for the import of one or several gases into fluids. The selectivities and/or permeabilities of the hollow and flat membranes may, in accordance with the intended application, be larger or smaller than those of the hollow or flat membrane structures formed. Media flows may be established in the hollow membrane and/or on the flat membranes.

For example, two components can be separated out of a multi-component mixture with a subsequent particular selection.

To this end, the hollow membrane is embedded halfway in different polymers and is permeable for example for two components of a fluid. Both components permeate through the hollow membrane depending on the drive force applied (for example, pressure, concentration) and are separated in accordance with the properties of the two flat membranes layers depending on the drive forces (for example, charge, concentration) each exiting from one side of the membrane.

In first method steps using the hollow flat membrane arrangement, first two components are separated from a fluid. Subsequently, these two components are separated from each other.

Analogous therewith, the same separation result could be achieved with the separation of two components from a fluid with a subsequent selection of the components when the fluid comes into contact with one side of the flat membrane whereby the two components are separated in a drive force- and/or material dependent manner. One of the drive force- and/or material dependent components permeates into the hollow membrane whereas the drive component permeates through the flat membrane, but not into the hollow membrane.

What is claimed is:

1. A membrane body (10) comprising at least one flat membrane and a hollow membrane (11) at least partially surrounded by said at least one flat membrane (12).

2. A membrane body (10) according to claim 1, wherein said hollow membrane (11) is fully surrounded by said at least one flat membrane (12).

3. A membrane body (10) according to claim 1, wherein said hollow membrane (11) is surrounded by at least two flat membranes (12).

4. A membrane body (10) according to claim 1, wherein said hollow membrane (11) and said at least one flat membrane, (12) are interconnected.

5. A membrane body (10) according to claim 1, wherein said hollow membrane (11) and said at least one flat membrane (12) consist of at least one polymer, or co-polymer.

6. A membrane body (10) according to claim 1, wherein at least two hollow membranes are provided and form a hollow membrane mat or hollow membrane bundle consisting preferably of polypropylene.

7. A membrane body (10) according to claim 1, wherein the flat membrane (12) is manufactured from a polymer solution.

8. A membrane body (10) according to claim 7, wherein said polymer solution is 10% polyacrylnitrile/dimethylformamide polymer solution.

9. A membrane body (10) according to claim 1, wherein said membrane body includes reinforcement structures in the form of one of particles, fleece and fiber structures disposed in the polymer solution.

10. A method for the manufacture of a membrane body (10) comprising the steps of: providing at least one hollow membrane (11) and applying to said at least one hollow membrane (11), a flat membrane (12) such that the flat membrane (11) at least partially surrounds said hollow membrane.

11. A method according to claim 10, wherein said hollow membrane 11 and said flat membrane 12 are interconnected.

12. A method according to claim 10, wherein said hollow membrane (11) and said flat membrane consist of at least one of a polymer and a copolymer.

13. A method according to claim 10, wherein said hollow membrane (11) is combined with at least a second hollow membrane (11) to form a hollow membrane mat or bundle.

14. A method according to claim 13, wherein said hollow membrane mat or bundle consists of propylene.

15. A method according to claim 10, wherein said flat membrane (12) is formed from a polymer solution.

16. A method according to claim 15, wherein said polymer solution consists of polyacrylnitrile/dimethylformamide.

17. A method according to claim 10, wherein said polymer forming said membrane body includes reinforcement means consisting of at least one of particles, a fleece and fibers.
